(19) United States
(12) Patent Application Publication
(10) Pub. No.: US 2024/0346386 A1
(43) Pub. Date: Oct. 17, 2024

(54) TIME SERIES FORECASTING USING UNIVARIATE ENSEMBLE MODEL

(71) Applicant: Snowflake Inc., Bozeman, MT (US)

(72) Inventors: Michel Adar, Campbell, CA (US); Boxin Jiang, Sunnyvale, CA (US); Anh Quynh Kieu, Bellevue, WA (US); Boyu Wang, Menlo Park, CA (US)

(21) Appl. No.: 18/133,477

(22) Filed: Apr. 11, 2023

(51) Int. Cl. G06N 20/20

(52) U.S. Cl. CPC G06N 20/20

(57) ABSTRACT

Disclosed is a fast and accurate time series forecasting algorithm that eliminates the need for hyperparameter tuning. Time series data may be analyzed using a quadratic function to determine a quadratic trend prediction, which is removed from the time series data to generate first detrended time series data. A moving median of the time series data is determined and the moving median is removed from the time series data to generate second detrended time series data. An amplitude scaling factor is determined based on the second detrended time series data and the first detrended time series data is descaled using the amplitude scaling factor to generate descaled time series data. The descaled time series data is analyzed to determine a seasonal prediction and a time series forecast is generated based on the seasonal prediction, the quadratic trend prediction, and the amplitude scaling factor.

### TECHNICAL FIELD

Aspects of the present disclosure relate to time series analysis, and more particularly, to an enhanced regression model and trend model ensemble algorithm for time series forecasting.

### BACKGROUND

Time-series analysis often refers to a variety of statistical modeling techniques including trend analysis, seasonality/cyclicality analysis, and anomaly detection. Predictions based on time-series analysis are extremely common and used across a variety of industries. For example, such predictions are used to predict values that change over time including weather patterns that can impact a range of other activities and sales that impact revenue forecasts, stock price performance, and inventory stocking requirements. In addition, time series analysis can be used in medicine to establish baselines for heart or brain function and in economics to predict interest rates.

Time-series predictions are built by complex statistical models that analyze historical data. There are many different types of time series models (e.g. auto-regressive, moving average, exponential smoothing) and many different regression models (e.g. linear, polynomial). All models have multiple parameters on which they can be built. Modern data scientists leverage machine learning (ML) techniques to find the best model and set of input parameters for the prediction they are working on.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram that illustrates an example ensemble time series forecasting model, in accordance with some embodiments of the present disclosure.

FIG. 3 is a block diagram illustrating the process of generating a time series forecast using the time series forecasting model of FIG. 2, in accordance with some embodiments of the present disclosure.

FIG. 4A-4F are graphs illustrating various aspects of the process of generating a time series forecast using the time series forecasting model of FIG. 2, in accordance with some embodiments of the present disclosure.

FIG. 5 is a graph illustrating the filtering of Fourier frequencies, in accordance with some embodiments of the present disclosure.

FIGS. 6A and 6B are graphs illustrating generation of a time series forecast without implementing a flattening of an Epoch time feature and with implementing a flattening of an Epoch time feature respectively, in accordance with some embodiments of the present disclosure.

FIGS. 7A and 7B illustrate the structure and function of a regression model, in accordance with some embodiments of the present disclosure.

FIG. 8 is a flow diagram of a method for generating a time series forecast using the ensemble time series forecasting model of FIG. 2, in accordance with some embodiments of the present disclosure.

FIG. 9 is a block diagram of an example computing device that may perform one or more of the operations described herein, in accordance with some embodiments of the present disclosure.

### DETAILED DESCRIPTION

Time series forecasting is a common task in time series analysis and is one of the most commonly utilized features by data analysts. Many data providers have built-in forecasting support that is based on any of a number of algorithms currently in use such as exponential smoothing, ARIMA, and Prophet. However, obtaining accurate forecasting is challenging and many of the algorithms currently being used for time series forecasting have considerable drawbacks. For example, many algorithms can only fit a linear trend or only one seasonal component, which is an invalid assumption in most use cases. Other algorithms are slow to train and can consume a lot of memory, while also lacking features such as support for multiple seasonal components and holiday effects. In addition, many algorithms suffer from relatively low accuracy unless they are tuned with domain knowledge and ML expertise. In addition to the above, it is also important for a forecasting algorithm to support exponential growth as well as multiplicative model decomposition for time-series data.

Embodiments of the present disclosure provide a fast (real-time) and accurate time series forecasting algorithm. Time series data may be analyzed using a quadratic function to determine a quadratic trend prediction. The quadratic trend prediction may be removed from the time series data to generate first detrended time series data. A moving median trend may be determined based on a moving median of the time series data and the moving median trend may be removed from the time series data to generate second detrended time series data. An amplitude scaling factor may be determined based on the second detrended time series data and the first detrended time series data may be descaled using the amplitude scaling factor to generate descaled time series data. The descaled time series data may be analyzed using an attributes model to determine a seasonal prediction and a time series forecast may be generated based on the seasonal prediction, the quadratic trend prediction, and the amplitude scaling factor.

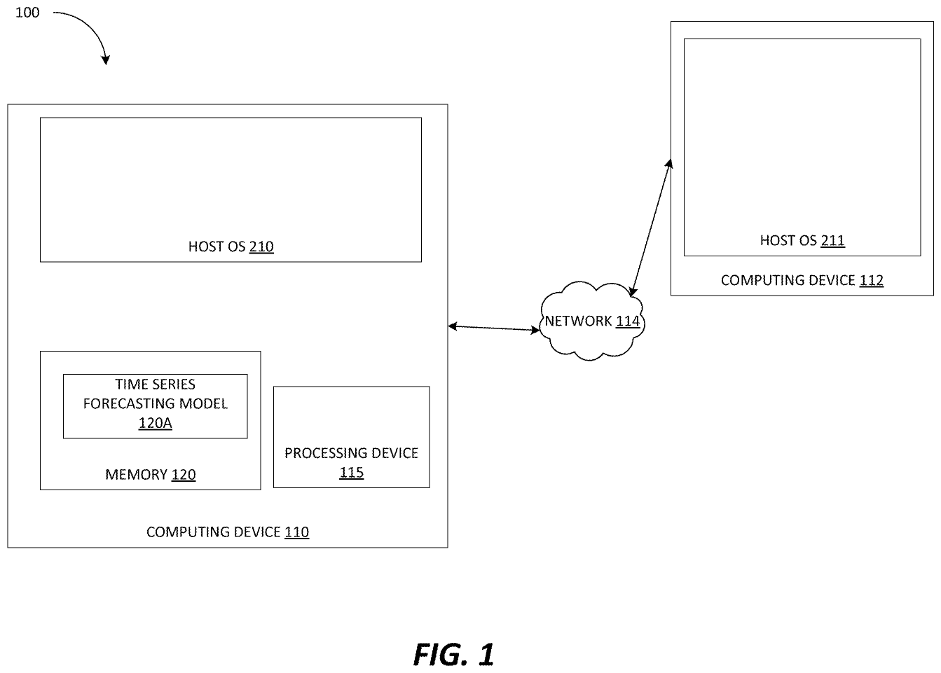

FIG. 1 is a block diagram that illustrates an example system 100. As illustrated in FIG. 1, the system 100 includes a computing device 110, and a plurality of computing device 112. The computing devices 110 and 112 may be coupled to each other (e.g., may be operatively coupled, communicatively coupled, may communicate data/messages with each other) via network 114. network 114 may be a public network (e.g., the internet), a private network (e.g., a local area network (LAN) or wide area network (WAN)), or a combination thereof. In one embodiment, network 114 may include a wired or a wireless infrastructure, which may be provided by one or more wireless communications systems, such as a WiFi™ hotspot connected with the network 114 and/or a wireless carrier system that can be implemented using various data processing equipment, communication towers (e.g., cell towers), etc. In some embodiments, the network 114 may be an L3 network. The network 114 may carry communications (e.g., data, message, packets, frames, etc.) between computing device 110 and computing device 112. Each computing device 110 and 112 may include hardware such as processing device 115 (e.g., processors, central processing units (CPUs)), memory 120 (e.g., random access memory 120 (e.g., RAM)), storage devices (e.g., hard-disk drive (HDD), solid-state drive (SSD), etc.—not shown), and other hardware devices (e.g., sound card, video card, etc.—not shown). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 112 may comprise a single machine or may include multiple interconnected machines (e.g., multiple servers configured in a cluster). The computing devices 110 and 112 may be implemented by a common entity/organization or may be implemented by different entities/organizations. For example, computing device 110 may be operated by a first company/corporation and one or more computing device 112 may be operated by a second company/corporation. Each of computing device 110 and computing device 112 may include an operating system (OS) such as host OS 210 and host OS 211 respectively, as discussed in more detail below. The host OS of a computing device 110 and 112 may manage the execution of other components (e.g., software, applications, etc.) and/or may manage access to the hardware (e.g., processors, memory, storage devices etc.) of the computing device. In some embodiments, each of computing device 110 and computing device 112 may constitute a deployment of a cloud data platform or data exchange.

As shown in FIG. 1, the memory 120 may include a time series forecasting module 120A which may be executed by the processing device 115 in order to perform some or all of the functions described herein.

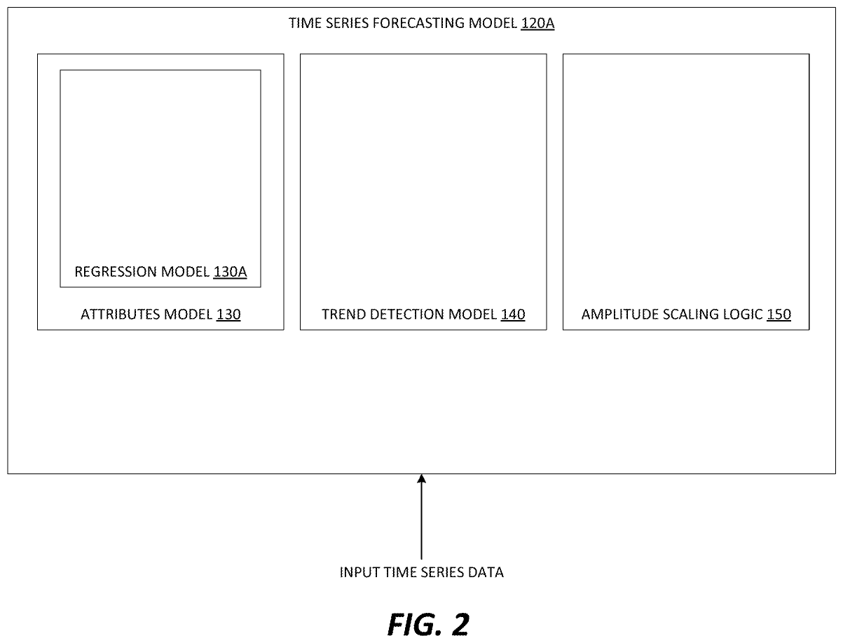

FIG. 2 illustrates the time series forecasting module 120A in accordance with some embodiments of the present disclosure. The time series forecasting module 120A may comprise 3 primary components, the attributes model 130, the trend detection model 140 and the amplitude scaling logic 150. The attributes model 130 may capture seasonality features (also referred to herein as seasonal components) of the input time series data while the trend detection model 140 captures trends within the input time series data. The amplitude scaling logic 150 may decouple the trend amplitude change and the seasonality amplitude change and allow the amplitude of the seasonality periods to scale independently by determining an amplitude scaling factor. The time series forecasting module 120A may be a multiplicative model (i.e., a model where predictions generated by each model in the ensemble are multiplied to generate the forecast). Stated differently, the time series forecasting module 120A's forecasting result may be computed by multiplying the seasonality prediction, the trend prediction and the amplitude scaling factor (y_{pred}=trend_{pred}*amplitude scaling factor*seasonality_{pred}).

The attributes model 130 may comprise a regression model 130A that has been modified to perform time series forecasting as discussed in further detail herein. For example, the regression model 130A may comprise an XGBoost model having an optimized and distributed gradient boosting library designed to be highly efficient, flexible and portable. The regression model 130A may implement machine learning algorithms under the gradient boosting framework. In some embodiments, the regression model 130A may provide (in addition or alternatively to the XGBoost model) a parallel tree boosting (also known as GBDT, or gradient boosting machine (GBM)) model that solves many data science problems in a fast and accurate way.

The attributes model 130 may be trained using any appropriate dataset. The training dataset may comprise a collection of real-world time series data sets of different observation frequencies (e.g., yearly, quarterly, monthly, weekly, daily, hourly, minutely, and secondly) and from different domains (e.g., micro, industry, macro, finance, and demographic, among others).

As can be seen, the time series forecasting module 120A comprises an ensemble of the attributes model 130, the trend detection model 140 (i.e., an ensemble of XGBoost prediction and quadratic prediction), and the amplitude scaling logic 150. Since both the attributes model 130 and the trend detection model 140 model learn on the same input data there will sometimes be features that are learned twice, and therefore get propagated disproportionately more in the prediction result. To overcome this, the time series forecasting module 120A may decompose the input time series data to allow the different models to focus on learning different aspects of the time-series data. The time series forecasting module 120A may decompose the input time series data into 3 different aspects: trend, amplitude scale, and seasonality.

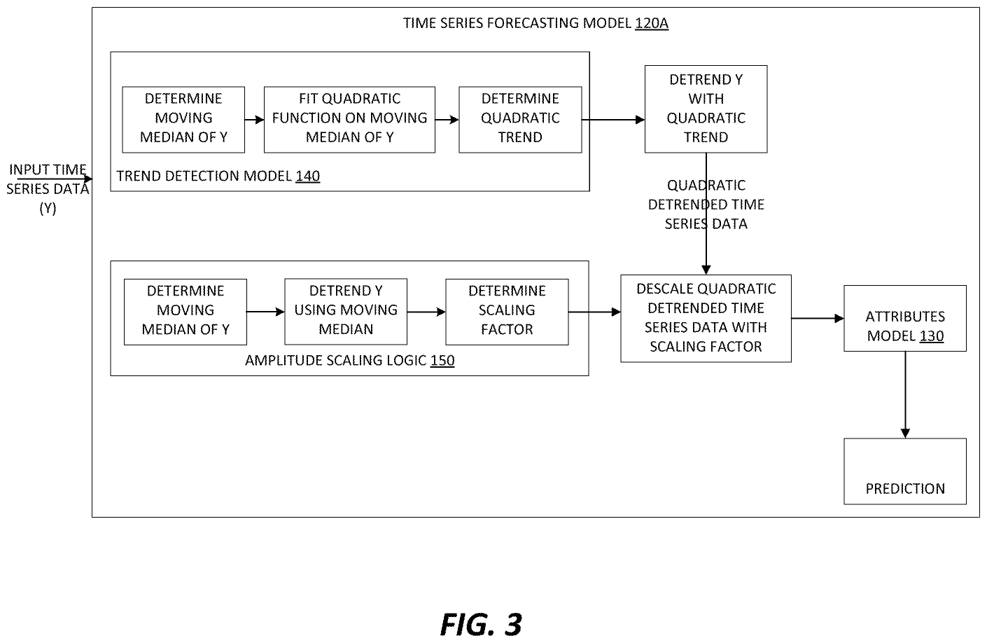

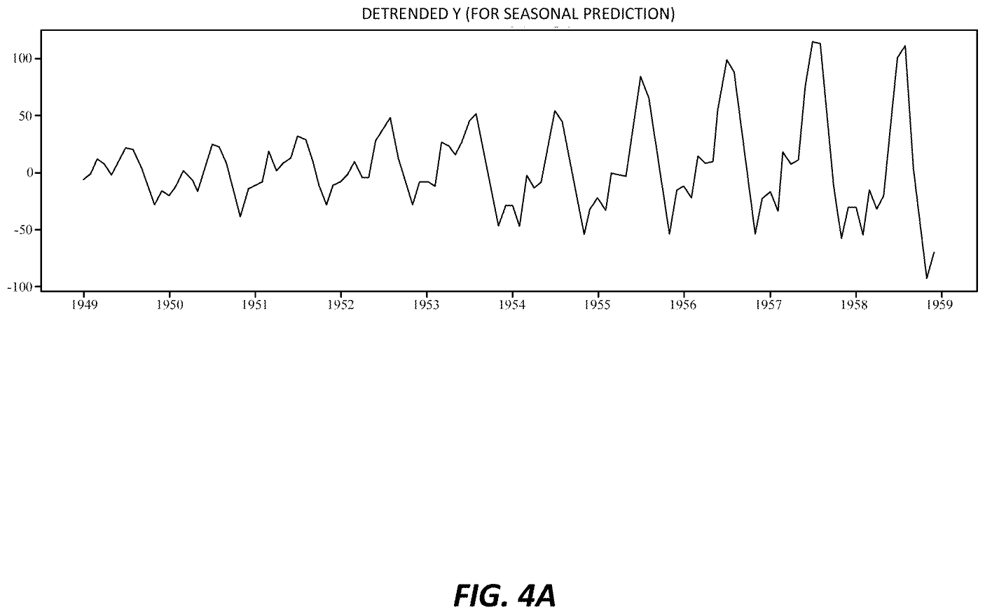

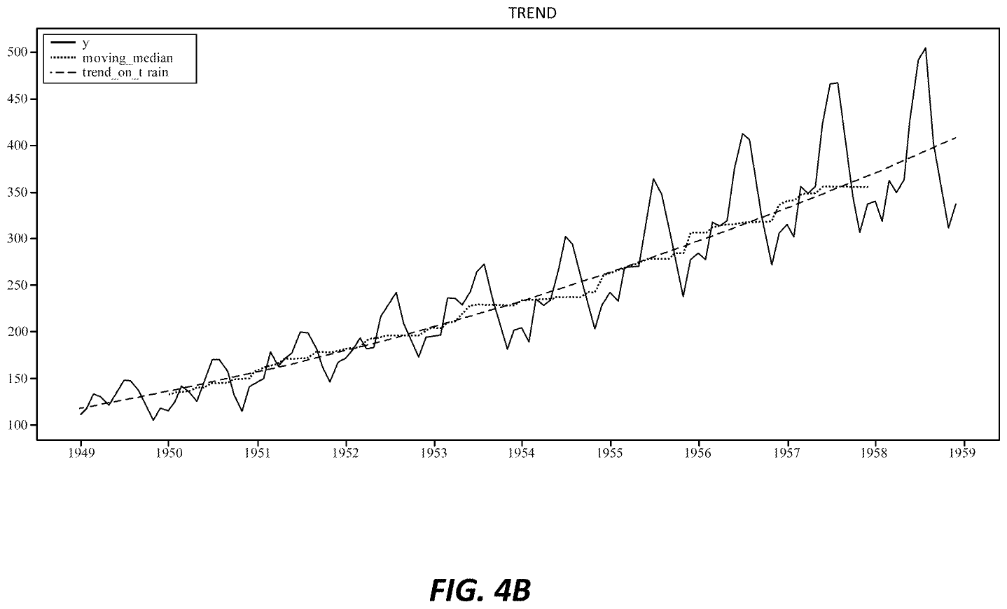

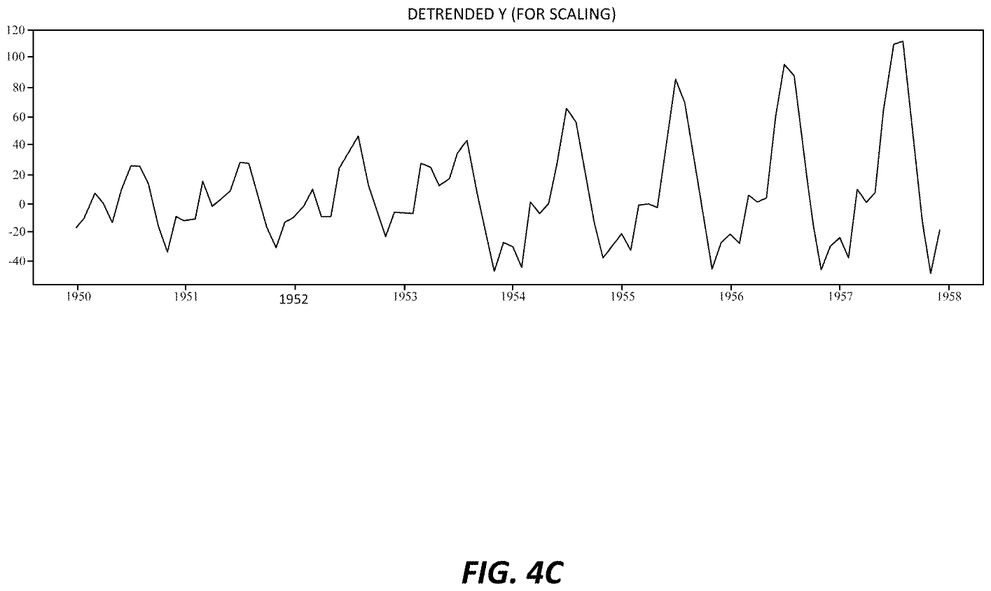

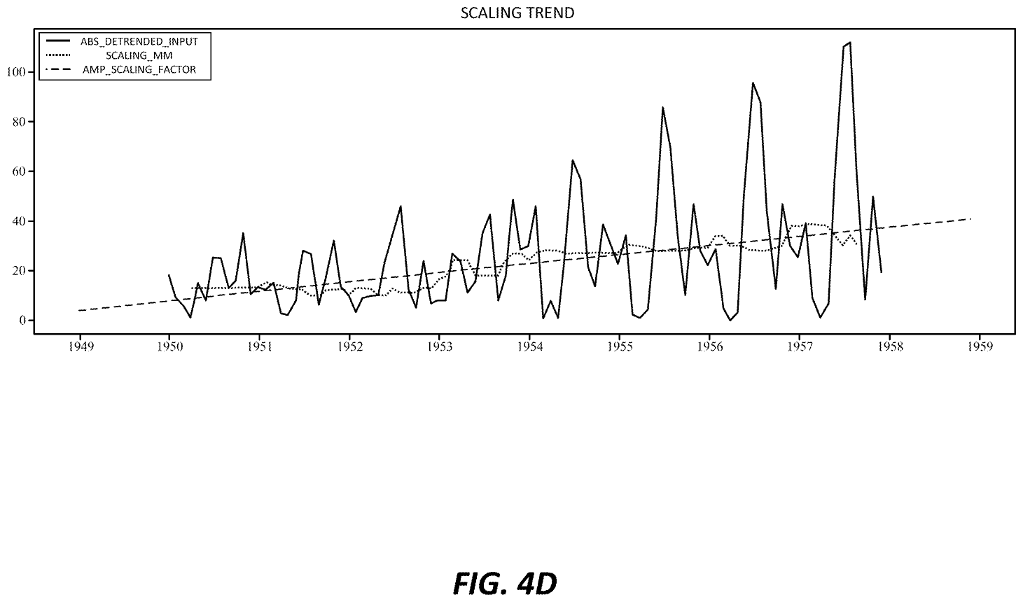

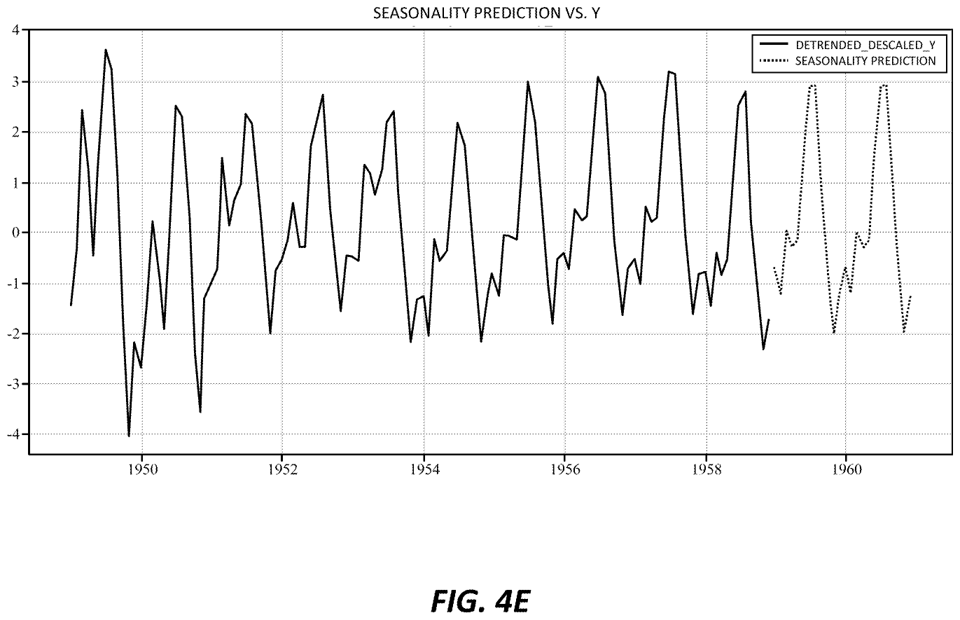

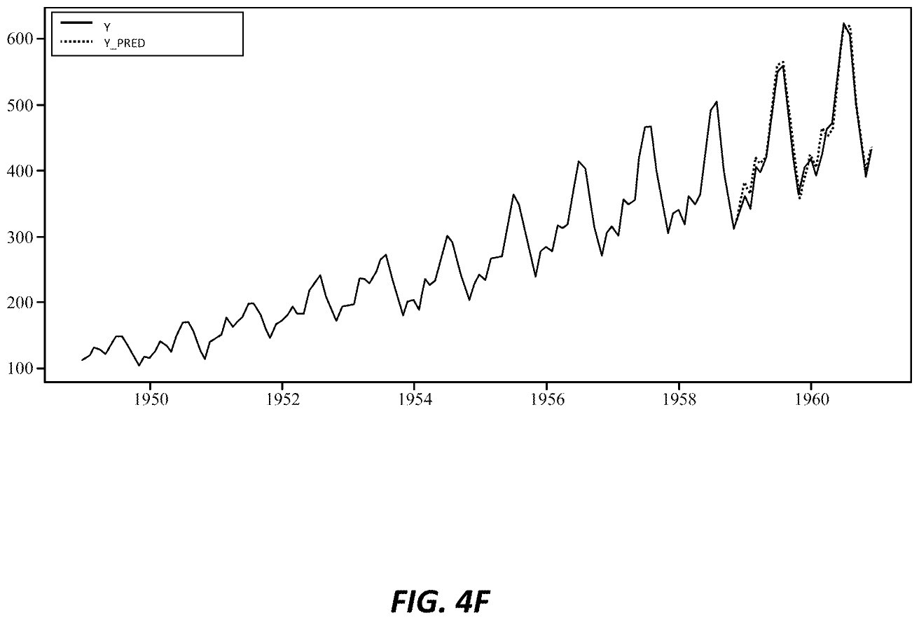

FIG. 3 illustrates the process of generating a time series forecast in accordance with some embodiments of the present disclosure. The trend detection model 140 may analyze the input time series data to compute the trend. The trend detection model 140 may utilize a quadratic function to determine the trend since a quadratic function can simulate both linear and exponential growth by changing the coefficients accordingly, which eliminates the need for model hyperparameter tuning (as discussed in further detail herein). Instead of fitting the quadratic function on the entire input time series data, the trend detection model 140 may compute the moving median of the input time series data first (the method of calculating the moving median of input time series data is discussed in further detail). By fitting the quadratic function on the moving median of the input time series data, the trend is determined based on (fitted to) smoother data that is more resistant to outliers. The trend prediction determined using the trend detection model 140 may be referred to hereinafter as the quadratic trend (also referred to herein as quadratic trend_{pred}) and input time series data that is detrended using the quadratic trend may be referred to hereinafter as quadratically detrended input time series data. After computing the quadratic trend, the time series forecasting module 120A may subtract the quadratic trend from the input time series data to detrend the input time series data, thereby resulting in quadratically detrended time series data. FIG. 4A illustrates the quadratically detrended time series data (i.e., detrended input time series data when it has been detrended using the quadratic fit of the trend detection model 140).

As discussed herein, the time series forecasting module 120A may be a multiplicative model where predictions generated by each model in the ensemble are multiplied to generate the forecast). Multiplying the seasonality prediction by the trend prediction assumes that the amplitude of the seasonality changes at the same rate as the amplitude of the trend. However, this is not always the case, and the amplitude of the seasonality and the amplitude of the trend are often decoupled. Thus, for the time series forecasting module 120A to be more descriptive on the input time series data, the amplitude scaling logic 150 may decouple the trend amplitude change and the seasonality amplitude change and allow the amplitude of the seasonality periods to scale independently.

Referring back to FIG. 3, to trace the seasonality amplitude change, the time series forecasting module 120A may include amplitude scaling logic 150. The amplitude scaling logic 150 may first detrend the input time series data and may then fit a linear trend onto the absolute value of detrended input time series data to determine an amplitude scaling factor. However, with amplitude scaling trend fitting, it is preferable to detrend using an element that closely follows the shape of the input time series data, which in this case is the moving median. Detrending with a moving median (instead of the quadratic trend) ensures that the graph of the detrended input time series data will be somewhat symmetric around the y-axis (e.g., a cone-shape that is symmetrical around the y=0 line), which produces a much better result for determining the amplitude scaling factor. Input time series data that is detrended using the moving median may be referred to hereinafter as median detrended input time series data.

To compute the moving median of the input time series data, we use a centered rolling window of 31, or ⅓ of the length of the input time series data, whichever value is smaller. This is because it is desirable for the rolling window to be at most ⅓ of the input time series data length, so that the moving median does not have too few data points. After determining the rolling window size, the amplitude scaling logic 150 may determine whether the rolling window size is an odd number and if not, alter the rolling window size to be an odd number. For example, if the rolling window size is even, the amplitude scaling logic 150 may add 1 to the size. It should be noted that the moving median is used as opposed to the moving average, since the moving median is more robust to one-point outliers.

There are scenarios where it is desirable to include more points at the beginning and the end of the input time series data, especially for smaller datasets. Therefore, in some embodiments the amplitude scaling logic 150 may also determine a minimum period value that allows moving median computation at an index if a number of observations greater than or equal to the minimum period value is observed in the rolling window. In some embodiments, the amplitude scaling logic 150 may adjust the minimum period value to be ⅔ of the original rolling window value.

FIG. 4B illustrates the calculated moving median (shown as moving_median in FIG. 4B) of the input time series data (Y), and a trend (shown as trend_on_train in FIG. 4B) being fit onto the calculated moving median. The amplitude scaling logic 150 may subtract the calculated moving median from the input time series data to generate the median detrended input time series data as shown in FIG. 4C. As shown in FIG. 4C, after detrending, the median detrended input time series data has a cone-like shape around the y-axis. After detrending, the amplitude scaling logic 150 may take the absolute value of the median detrended input time series data (shown in FIG. 4D as abs_detrended_input), determine a moving median of the absolute value of the median detrended input time series data (shown in FIG. 4D as scaling_mm), and fit a linear trend on the moving median of the absolute value of the median detrended input time series data to calculate the amplitude scaling factor (shown in FIG. 4D as amp_scaling_factor). This process is illustrated in FIG. 4D.

It should be noted that although illustrated and described as both of the amplitude scaling logic 150 and the trend detection model 140 independently calculating the moving median of the input time series data, this is not a limitation and the amplitude scaling logic 150 may use the moving median calculated by the trend detection model 140 or the trend detection model 140 may utilize the moving median calculated by the amplitude scaling logic 150.

The amplitude scaling logic 150 may subsequently descale the quadratically detrended input time series data by dividing the quadratically detrended input time series data by the amplitude scaling factor, thereby resulting in descaled and detrended input time series data (hereinafter referred to as descaled input time series data). The descaled input time series data is shown in FIG. 4E as detrended_descaled_y. However, the amplitude scaling logic 150 must consider the case where the amplitude scaling factor becomes too small, thus resulting in small-scale division. To prevent small-scale division of the quadratically detrended input time series data, the amplitude scaling logic 150 may create a lower threshold of the amplitude scaling factor, capping it at e.g., 10% of the maximum input scale (although any appropriate fraction of the maximum input scale may be used). The lower threshold of the amplitude scaling factor also assumes that the amplitude of the input time series data will not decrease lower than 10% of the maximum amplitude.

Upon obtaining the descaled input time series data, the time series forecasting module 120A may execute the attributes model 130, which may determine the seasonality prediction (also referred to herein as Seasonality_{pred}) by fitting the descaled input time series data into the regression model 130A to generate the seasonality prediction (shown as Seasonality_{pred} in FIG. 4E). It should be noted that unlike the amplitude scaling logic 150, the attributes model 130 analyzes data that has been quadratically detrended (i.e., the descaled input time series data). This is because the moving median can contain seasonality information and since algorithms such as XGBoost focus on learning seasonality, detrending with the quadratic trend avoids losing some seasonal amplitude compared to detrending with only the moving median which may result in the loss of significant seasonal amplitude.

Finally, the time series forecasting module 120A may determine the forecast (also referred to herein as y_{pred}) using the following formula:

y_{pred}=Seasonality_{pred}*amplitude scaling factor+quadratic trend_{pred}

FIG. 4F illustrates the forecast (shown in FIG. 4F as y_{pred}) generated by the time series forecasting module 120A.

Forecasting models often engage in feature (also referred to as hyperparameter) selection tuning. Examples of features can include timestamp derived features, number of trees in the boosted model, the maximum step of each tree during training, and linear trend training horizon. Time series forecasting models often use trial and error to try different sets of features to find the set of features that results in the least amount of error in their output. More specifically, time series forecasting models take away from the input time series data, some holdout period that is equal to the number of forecasting steps. The models can then look at the result of each model type on this holdout period, and choose which one produces the most accurate prediction based on some metrics. This model selection method is useful as it provides more model options for the algorithm to adapt to different input data shapes. However, this model tuning method can create instability in the forecasting period, as the holdout period is dependent on the number of forecasting steps.

As a result, forecasting models in accordance with embodiments of the present disclosure do not engage in hyperparameter selection tuning/select among different model types. Instead, the time series forecasting module 120A utilizes the amplitude scaling logic 150 to perform amplitude scaling independently, which enables the time series forecasting module 120A to be flexible enough to adapt to cases with no trend scaling, and thus does not require model hyperparameter tuning.

In some embodiments, the time series forecasting module 120A may filter Fourier features using max peak and autocorrelation function (ACF) techniques. More specifically, the time series forecasting module 120A may select Fourier features whose period spans more than ½ of the length of the input time series data. This change ensures that the chosen features must repeat at least twice before being in the learning feature set. For example, if the input time series data has 300 data points, any frequency with a corresponding period of over 150 will not be included in the final learning feature set. Once the time series forecasting module 120A obtains the Fourier features with suitable period lengths, it may retain only those features with enough significance. More specifically, the time series forecasting module 120A may choose among the Fourier features whose magnitude of frequency is at least 30% of the most frequent feature (which may be set as a significance threshold). The time series forecasting module 120A may disregard Fourier features having a magnitude of frequency less than the significance threshold.

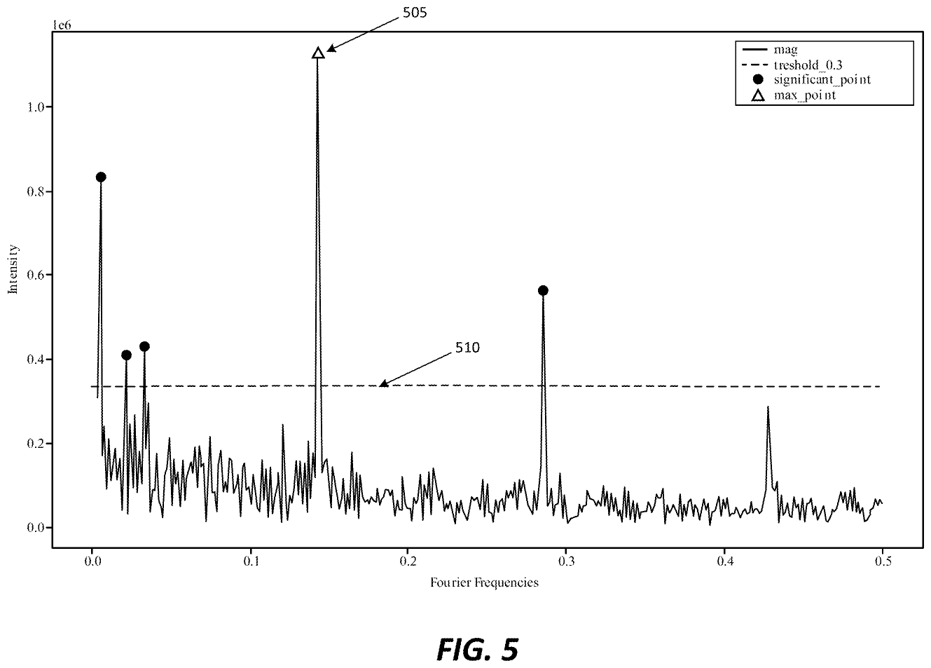

FIG. 5 illustrates a graph 500 of the intensity of different Fourier feature frequencies within an input dataset and demonstrates how the significance threshold works. The triangle 505 corresponds to the Fourier feature having the most significant frequency (i.e., the most significant feature), and the threshold line 510 represents the 30% threshold point of the most significant feature. Any frequency peaks above the threshold line 510 correspond to a Fourier feature that should be included in the feature set, while other points are discarded.

In addition, not all Fourier frequencies should be considered seasonal features as some can correspond to white noise-signals that are not auto-correlated. Hence, the time series forecasting module 120A may filter out white noise frequencies from the list of Fourier frequencies. To do this, the time series forecasting module 120A may use the autocorrelation function (ACF). Using ACF and a white noise threshold, the time series forecasting module 120A can filter out white noise frequencies. White noises often have low ACF values that range between +2/NT, with T being the length of the input time series data. By keeping only features whose ACF values are outside of the white noise range, the time series forecasting module 120A may filter out white noise from the feature list.

In some embodiments, the time series forecasting module 120A may also remove universal unique identifier (UUID) features. UUID features refer to features that will be a unique identifier when being fed to the XGB model. UUID features may be present when the time series does not span a significant period of time. For example, if the time series spans a year or less, any feature that is unique to a duration of one year, like day of year, month, quarter, etc., should be removed. It is ideal to remove these UUID features as UUID features can make the XGB model overfit to a specific value at the UUID. For example, if there is an outlier on the 56th day of the year within input time series data spanning less than one year, the regression model 130A will likely predict the outlier value on the 56th day of the next year.

Thus, the time series forecasting module 120A may identify a feature as a UUID feature if the feature is not repeated at least a threshold number of times (e.g., 3 times) within the time span of the input time series data. For example, if the input time series data spans 2 years, the time series forecasting module 120A will not consider the “day of year” as a feature (i.e., will consider it a UUID feature and remove it). This approach requires the user to provide the time series forecasting module 120A with a dataset that spans at least 3 full seasonality periods to produce an accurate prediction result.

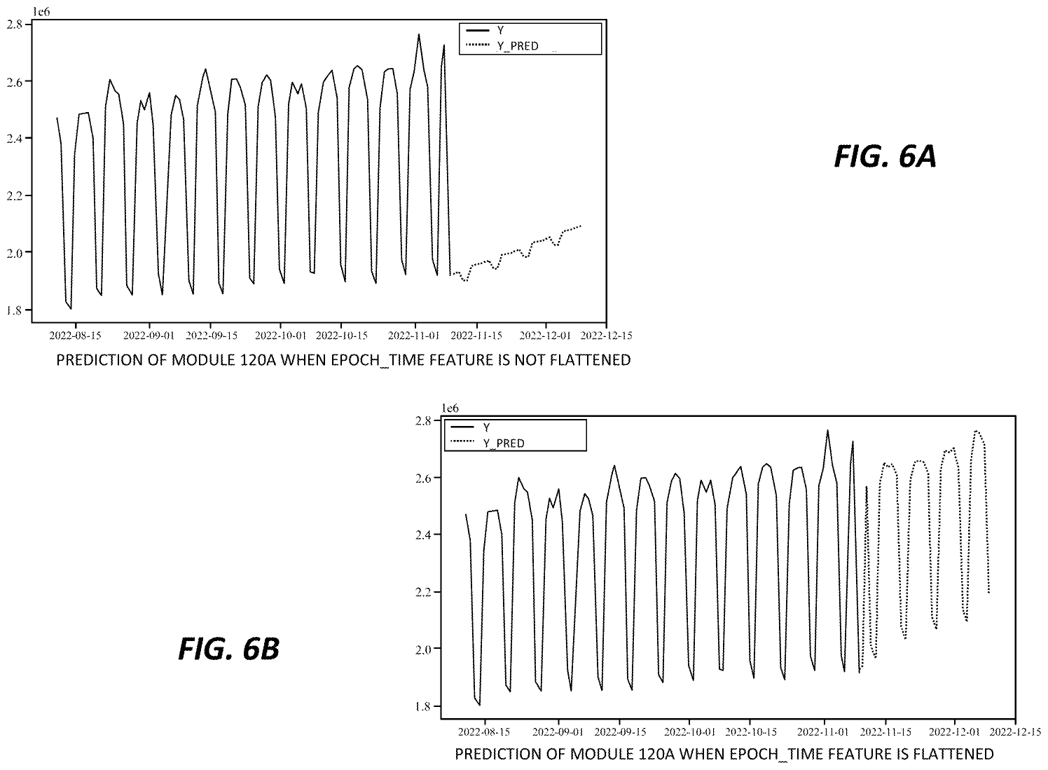

The regression model 130A may have a number of learning features, including Epoch time. Epoch time is incremental, and is used to better fit the input time series data. However, Epoch time may cause the regression model 130A to overfit and as a result, fit outliers into the ultimate prediction. This is particularly problematic when the last point in the input time series data is an outlier. To reduce the effect of this last point, the time series forecasting module 120A may flatten out the Epoch time of the last 30 points of the input time series data. If the input time series data does not have enough points, the time series forecasting module 120A may flatten ⅓ of the input time series data instead. In other words, the Epoch time of the most recent data points will be flattened to be the same, so that the regression model 130A is not significantly affected by the outlier effect from the last point. To demonstrate how the results differ with flattening epoch time feature, FIGS. 6A and 6B illustrate prediction results on input time series data with an anomalous last point without the Epoch time feature flattened and with the Epoch time feature flattened respectively. The input time series data has an anomalous last point because the last point is supposed to be the peak of the seasonal period. Instead, the last point drops to a low value. This unexpected drop skews the prediction of the regression model 130A, as shown in FIG. 6A. However, if the time series forecasting module 120A flattens the Epoch time feature for the last 30 points, it may obtain a better prediction as shown in FIG. 6B.

The time series forecasting module 120A may also flatten other features that are unique during the flattened period so that the regression model 130A will not pass the Epoch time effect onto those features as well. For example, instead of using epoch time, the regression model 130A may use “day of month” during the Epoch time flattening period to describe and learn the effect of the outlier.

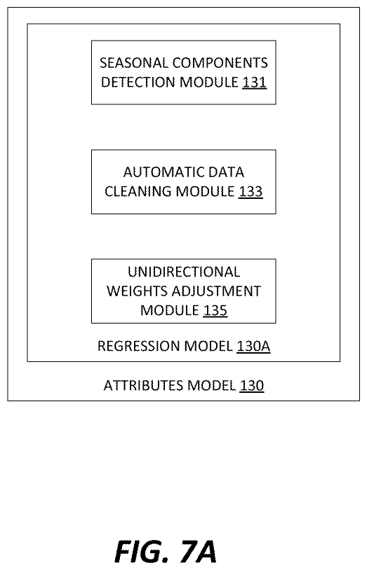

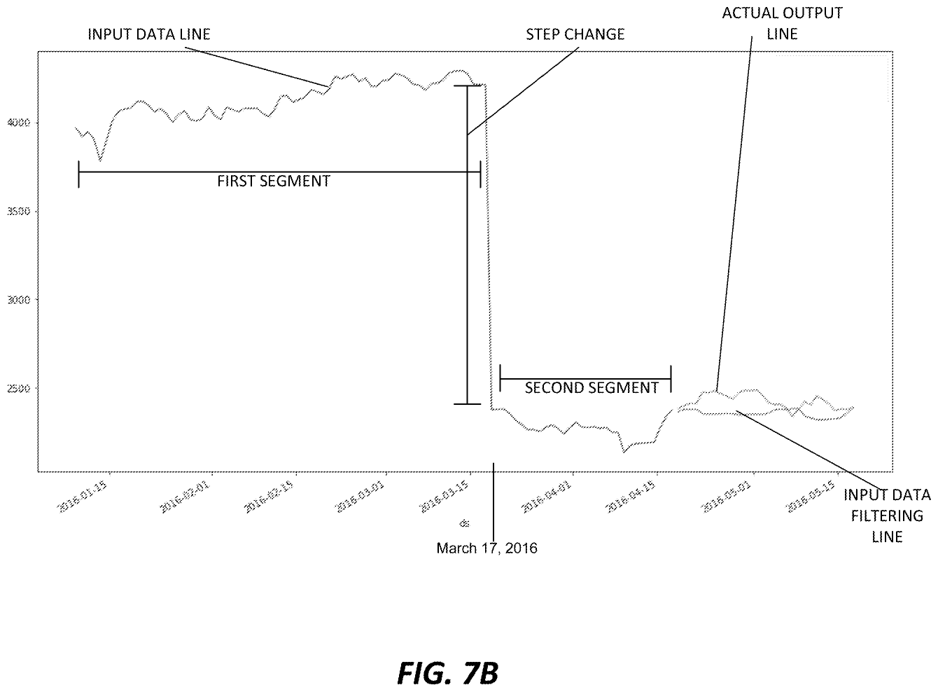

FIG. 7A illustrates the structure of the regression model 130A in accordance with some embodiments of the present disclosure. The regression model 130A may include a seasonal components detection module 131 that enables it to extract features from the input data using natural language processing and/or any other appropriate means for extracting features from the input data. The regression model 130A may extract all possible seasonal components from time series input data including e.g., hour of day, day of week, week of year, day of month, and month of year. During operation, the seasonal components detection module 131 may allow the regression model 130A to adjust the weights of extracted features according to the strength of the detected pattern(s). Thus, compared to other algorithms that use a fixed seasonal period, the regression model 130A may detect natural periods with a high accuracy. For example, the seasonal components detection module 131 may take the different numbers of days in each month of the year into account instead of simply assuming each month is a fixed number of days.

The input time series data may also include trends, step changes and noise (i.e., non-seasonal components). It is critical to strip these non-seasonal components from the input data (time series data) before detecting the seasonal components as non-seasonal components may cause all seasonal components to be amplified with a large variance, and the starting point of the forecasting may be sensitive to step changes. FIG. 7B illustrates the effect of non-seasonal components on sample input time series data. As can be seen in FIG. 7B, the large step change in the input data line has caused an amplification in the seasonal components of the attribute model line (representing the output of the seasonal components detection module 131 by itself) and has also caused the starting point of the forecasting (i.e., starting point of the attribute model line) to be skewed. However, separating the seasonal components from the non-seasonal components of the input data can be challenging. Thus, the attributes model 130 may be modified to include an automatic data cleaning module 133 which may serve to filter all such trends, step changes and noise (non-seasonal components) from the input data in order to clean the input data for seasonal components fitting.

During forecasting, the automatic data cleaning module 133 may produce an adjustment which may be applied to the input data by the attributes model 130 before seasonal component detection to remove any non-seasonal components from the input data. The adjustment may be represented by the input data filtering line shown in FIG. 7B, which is relatively flat and to which the regression model 130A may fit the input data to remove the non-seasonal components and anchor the starting point as shown in FIG. 7B. As can be seen, the input data filtering line of FIG. 7B may closely resemble the characteristics of the second segment of input data, which corresponds to the segment of input data received after the step change (e.g., Mar. 17, 2016-Apr. 17, 2016), instead of all of the input data received from Jan. 15, 2016. This is because the automatic data cleaning module 133 may continuously analyze the input data to sense/identify a current “context” of the input data and continuously update/modify the adjustment/input data filtering line based on the current context (e.g., continuously perform self-adaptive re-contextualization). The current context of the input data may refer to characteristics of a current segment of input data including the value of data points of the current segment (e.g., the average value of data points of the current segment) and/or the seasonal components/features extracted from the data points of the current segment. The automatic data cleaning module 133 may generate the adjustment/input data filtering line based on the current context (e.g., an average value of the data points of the current segment and e.g., common patterns in the seasonal components/features extracted from the series of data points of the current segment).

Referring to FIG. 7B, the automatic data cleaning module 133 may begin analyzing the input data beginning on Jan. 15, 2016 and on Feb. 1, 2016, may determine that the average value of data points analyzed thus far is 4000 (and that all or most of the data points are within a value threshold of 4000) and may determine the seasonal components as shown in FIG. 7B. The automatic data cleaning module 133 may determine that the first segment of input data from Jan. 15, 2016 to Feb. 1, 2016 includes values within the value threshold of 4000 and seasonal components of the first segment fit a common pattern (i.e., are within a seasonal components threshold). The automatic data cleaning module 133 may determine the current context of the input data based on the values of the series of data points (e.g., the average value) and/or the seasonal components/features (e.g., an average of the seasonal components/features) of the first segment. As the automatic data cleaning module 133 continues to analyze the input data, it may determine that the values of the input data through Mar. 16, 2016 are within the value threshold of 4000 and the seasonal components extracted from the input data through Mar. 16, 2016 are within the seasonal components threshold of the seasonal components extracted from the input data between Jan. 15, 2016 and Feb. 1, 2016. Thus, the automatic data cleaning module 133 may determine that the first segment may include the input data through Mar. 16, 2016 as well. It should be noted that input data can be analyzed to determine whether a new segment of the input data has begun (and thus whether the current context must be updated) with any appropriate frequency/granularity (e.g., hourly, daily, weekly) and with any appropriate level of accuracy. For example, the value and seasonal components thresholds may be set such that only data points of input data that are extremely close to each other in value and result in very consistent seasonal components may be identified as a segment of input data.

Continuing the example of FIG. 7B, on Mar. 17, 2016, the automatic data cleaning module 133 may determine that a change in the value of a data point(s) and/or change in the seasonal components is beyond their respective threshold and thus that the input data from Mar. 17, 2016 onwards corresponds to a new segment (second segment) of the input data and update the current context accordingly. More specifically, the decision tree generated by the regression model 130A will have one or more branches corresponding to data points of the input data before the large step change (e.g., before Mar. 17, 2016) that are around the 4000 value, and one or more branches corresponding to data points of the input data after the large step change (e.g., on or after Mar. 17, 2016) that are around the 2500 value. The automatic data cleaning module 133 may analyze the branches before and after the large step change, and sense that the context of the input data has changed sharply after the large step change.

The automatic data cleaning module 133 may recalculate the current context based on the characteristics of the second segment of input data including e.g., the average values of data points of the input data after the large step change, as well as the seasonal components of the input data (e.g., common patterns therein) after the large step change. When it is time to perform time series forecasting (e.g., on Apr. 16, 2016), the automatic data cleaning module 133 may then generate/modify the input data filtering line (i.e., the adjustment to the input data) based on the current context of the input data (based on the second segment). The regression model 130A may fit the input data to the input data filtering line in order to remove the effects of non-seasonal components such as trends, step changes and noise from the input data.

Although time series forecasting is sensitive to the freshness of the input data (i.e., the newer the data, the more weight it should receive), it can be challenging to adjust the weights applied to different segments of input data manually. Because the attributes model 130 is a tree based model that is unidirectional, the patterns learned from older segments of the input data can be dropped or have less weight assigned to them during forecasting, while newer segments of input data may be assigned a greater weight. Thus, the attributes model 130 may be modified with a unidirectional weights adjustment module 135 which may utilize the unidirectional nature of the attributes model 130's tree structure to automatically separate the entire input data into multiple segments based on common patterns (as discussed above with respect to the automatic data cleaning module 133), and apply weights to each segment in such a manner so that the more recent the segment of input data, the more weight it is assigned when being used for forecasting. In some embodiments, the unidirectional weights adjustment module 135 may determine different segments based on common patterns in a manner similar to that used by the automatic data cleaning module 133 to determine the current context of the input data. Although the less recent segments are dropped/assigned a lower weight, some common patterns (e.g., seasonal components) will be left. This also aids in missing value imputation. Based on the above discussion, it follows that the output of the automatic data cleaning module 133 (i.e., the input data filtering line) may often be given more weight when the attributes model 130 is determining the features of the input data.

Holidays (e.g., Christmas, Thanksgiving) may have a significant effect on time series data patterns. The attributes model 130 may handle holidays in two ways. First, the attributes model 130 may explicitly represent each holiday as an extra feature e.g., using a hot encoded holiday. Second, the attributes model 130 may implicitly rely on existing timestamp derived features. For example, the attributes model 130 may utilize the “day of the week” and “week of the year features” to capture “Martin Luther King Jr. Day.”

In tree algorithms such as the attributes model 130, branch directions for missing values are learned during training. Thus, the attributes model 130 may include the ability to fill in missing data values from the input data. In some embodiments, the attributes model 130 may ignore missing timestamps.

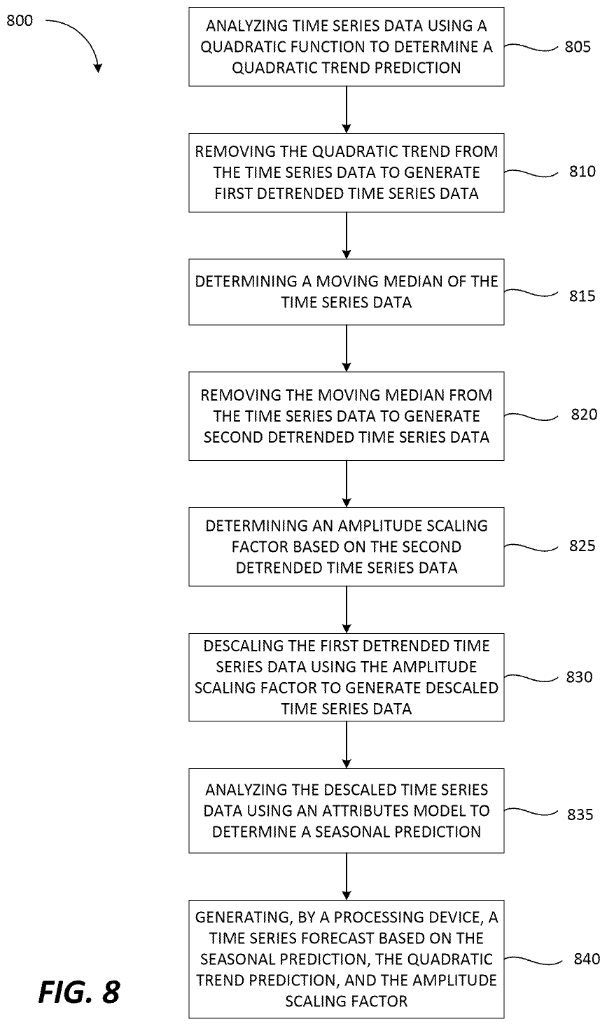

FIG. 8 is a flow diagram of a method 800 of performing a time series forecasting using a modified gradient boosting decision tree (GBDT) based algorithm, in accordance with some embodiments of the present disclosure. Method 800 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 800 may be performed by a computing device (e.g., computing device 110 executing the time series forecasting model 120A as illustrated in FIG. 2).

Referring also to FIG. 3, at block 805 the trend detection model 140 may analyze the input time series data to compute the trend. The trend detection model 140 may utilize a quadratic function to determine the trend since a quadratic function can simulate both linear and exponential growth by changing the coefficients accordingly, which eliminates the need for model hyperparameter tuning (as discussed in further detail herein). Instead of fitting the quadratic function on the entire input time series data, the trend detection model 140 may compute the moving median of the input time series data first (the method of calculating the moving median of input time series data is discussed in further detail). By fitting the quadratic function on the moving median of the input time series data, the trend is determined based on (fitted to) smoother data that is more resistant to outliers. The trend prediction determined using the trend detection model 140 may be referred to hereinafter as the quadratic trend (also referred to herein as quadratic trend_{pred}) and input time series data that is detrended using the quadratic trend may be referred to hereinafter as quadratically detrended input time series data. At block 810, after computing the quadratic trend, the time series forecasting module 120A may subtract the quadratic trend from the input time series data to detrend the input time series data, thereby resulting in quadratically detrended time series data. FIG. 4A illustrates the quadratically detrended time series data (i.e., detrended input time series data when it has been detrended using the quadratic fit of the trend detection model 140).

As discussed herein, the time series forecasting module 120A may be a multiplicative model where predictions generated by each model in the ensemble are multiplied to generate the forecast). Multiplying the seasonality prediction by the trend prediction assumes that the amplitude of the seasonality changes at the same rate as the amplitude of the trend. However, this is not always the case, and the amplitude of the seasonality and the amplitude of the trend are often decoupled. Thus, for the time series forecasting module 120A to be more descriptive on the input time series data, the amplitude scaling logic 150 may decouple the trend amplitude change and the seasonality amplitude change and allow the amplitude of the seasonality periods to scale independently. Stated differently, the time series forecasting module 120A's forecasting result may be computed by multiplying the seasonality prediction, and the trend predictions and the amplitude scaling factor (y_{pred}=trend_{pred}*amplitude scaling factor*seasonality_{pred}).

Referring also to FIG. 3, to trace the seasonality amplitude change, the amplitude scaling logic 150 may first detrend the input time series data and may then fit a linear trend onto the absolute value of detrended input time series data to determine an amplitude scaling factor. However, with amplitude scaling trend fitting, it is preferable to detrend using an element that closely follows the shape of the input time series data, which in this case is the moving median. Thus, at block 815, the amplitude scaling logic 150 may detrend the input time series data with a moving median (instead of the quadratic trend) to ensure that the graph of the detrended input time series data will be somewhat symmetric around the y-axis (e.g., a cone-shape that is symmetrical around the y=0 line), which produces a much better result for determining the amplitude scaling factor. Input time series data that is detrended using the moving median may be referred to hereinafter as median detrended input time series data.

To compute the moving median of the input time series data, the amplitude scaling logic 150 may use a centered rolling window of 31, or ⅓ of the length of the input time series data, whichever value is smaller. This is because it is desirable for the rolling window to be at most ⅓ of the input time series data length, so that the moving median does not have too few data points. After determining the rolling window size, the amplitude scaling logic 150 may determine whether the rolling window size is an odd number and if not, alter the rolling window size to be an odd number. For example, if the rolling window size is even, the amplitude scaling logic 150 may add 1 to the size. It should be noted that the moving median is used as opposed to the moving average, since the moving median is more robust to one-point outliers.

There are scenarios where it is desirable to include more points at the beginning and the end of the input time series data, especially for smaller datasets. Therefore, in some embodiments the amplitude scaling logic 150 may also determine a minimum period value that allows moving median computation at an index if a number of observations greater than or equal to the minimum period value is observed in the rolling window. In some embodiments, the amplitude scaling logic 150 may adjust the minimum period value to be ⅔ of the original rolling window value.

FIG. 4B illustrates the calculated moving median (shown as moving_median in FIG. 4B) of the input time series data (Y), and a trend (shown as trend_on_train in FIG. 4B) being fit onto the calculated moving median. At block 820, the amplitude scaling logic 150 may subtract the calculated moving median from the input time series data to generate the median detrended input time series data as shown in FIG. 4C. As shown in FIG. 4C, after detrending, the median detrended input time series data has a cone-like shape around the y-axis. At block 825, after detrending, the amplitude scaling logic 150 may take the absolute value of the median detrended input time series data (shown in FIG. 4D as abs_detrended_scaling), determine a moving median of the absolute value of the median detrended input time series data (shown in FIG. 4D as scaling_mm), and fit a linear trend on the moving median of the absolute value of the median detrended input time series data to calculate the amplitude scaling factor (shown in FIG. 4D as amp_scaling_trend). This process is illustrated in FIG. 4D.

It should be noted that although illustrated and described as both of the amplitude scaling logic 150 and the trend detection model 140 independently calculating the moving median of the input time series data, this is not a limitation and the amplitude scaling logic 150 may use the moving median calculated by the trend detection model 140 or the trend detection model 140 may utilize the moving median calculated by the amplitude scaling logic 150.

At block 830, the amplitude scaling logic 150 may subsequently descale the quadratically detrended input time series data by dividing the quadratically detrended input time series data by the amplitude scaling factor, thereby resulting in descaled and detrended input time series data (hereinafter referred to as descaled input time series data). The descaled input time series data is shown in FIG. 4E as detrended_descaled_y. However, the amplitude scaling logic 150 must consider the case where the amplitude scaling factor becomes too small, thus resulting in small-scale division. To prevent small-scale division of the quadratically detrended input time series data, the amplitude scaling logic 150 may create a lower threshold of the amplitude scaling factor, capping it at e.g., 10% of the maximum input scale (although any appropriate fraction of the maximum input scale may be used). The lower threshold of the amplitude scaling factor also assumes that the amplitude of the input time series data will not decrease lower than 10% of the maximum amplitude.

Upon obtaining the descaled input time series data, at block 835 the time series forecasting module 120A may execute the attributes model 130, which may determine the seasonality prediction (also referred to herein as Seasonality_{pred}) by fitting the descaled input time series data into the regression model 130A to generate the seasonality prediction (shown as Seasonality pred in FIG. 4E). It should be noted that unlike the amplitude scaling logic 150, the attributes model 130 analyzes data that has been quadratically detrended (i.e., the descaled input time series data). This is because the moving median can contain seasonality information and since algorithms such as XGBoost focus on learning seasonality, detrending with the quadratic trend avoids losing some seasonal amplitude compared to detrending with only the moving median which may result in the loss of significant seasonal amplitude.

Finally, at block 840 the time series forecasting module 120A may determine the forecast (also referred to herein as y_{pred}) using the following formula:

y_{pred}=Seasonality_{pred}*amplitude scaling factor+quadratic trend_{pred}

FIG. 4F illustrates the forecast (shown in FIG. 4F as y_{pred}) generated by the time series forecasting module 120A.

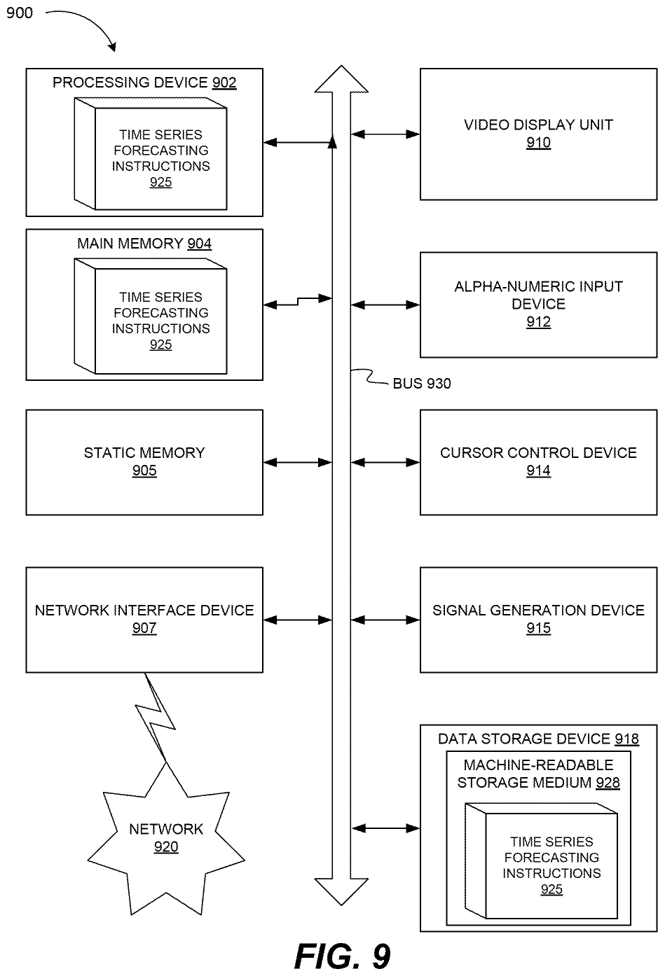

FIG. 9 illustrates a diagrammatic representation of a machine in the example form of a computer system 900 within which a set of instructions, for causing the machine to perform any one or more of the methodologies discussed herein for generating a time series forecast.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 900 may be representative of a server.

The exemplary computer system 900 includes a processing device 902, a main memory 904 (e.g., read-only memory (ROM), flash memory, dynamic random access memory (DRAM)), a static memory 905 (e.g., flash memory, static random access memory (SRAM), etc.), and a data storage device 918, which communicate with each other via a bus 930. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 900 may further include a network interface device 907 which may communicate with a network 920. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 915 (e.g., a speaker). In one embodiment, video display unit 910, alphanumeric input device 912, and cursor control device 914 may be combined into a single component or device (e.g., an LCD touch screen).

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute time series forecasting instructions 925, for performing the operations and steps discussed herein.

The data storage device 918 may include a machine-readable storage medium 928, on which is stored one or more sets of time series forecasting instructions 925 (e.g., software) embodying any one or more of the methodologies of functions described herein. The time series forecasting instructions 925 may also reside, completely or at least partially, within the main memory 904 or within the processing device 902 during execution thereof by the computer system 900; the main memory 904 and the processing device 902 also constituting machine-readable storage media. The time series forecasting instructions 925 may further be transmitted or received over a network 920 via the network interface device 907.

The machine-readable storage medium 928 may also be used to store instructions to perform a method for specifying a stream processing topology (dynamically creating topics, interacting with these topics, merging the topics, reading from the topics, and obtaining dynamic insights therefrom) via a client-side API without server-side support, as described herein. While the machine-readable storage medium 928 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
analyzing time series data using a quadratic function to determine a quadratic trend prediction;
removing the quadratic trend from the time series data to generate first detrended time series data;
determining a moving median of the time series data;
removing the moving median from the time series data to generate second detrended time series data;
determining an amplitude scaling factor based on the second detrended time series data;
descaling the first detrended time series data using the amplitude scaling factor to generate descaled time series data;
analyzing the descaled time series data using an attributes model to determine a seasonal prediction; and
generating, by a processing device, a time series forecast based on the seasonal prediction, the quadratic trend prediction, and the amplitude scaling factor.

2. The method of claim 1, wherein determining the amplitude scaling factor comprises:
computing a moving median of the second detrended time series data; and
fitting a linear trend on an absolute value of the moving median of the second detrended time series data to determine the amplitude scaling factor.

3. The method of claim 1, wherein descaling the quadratically detrended time series data comprises:
dividing the quadratically detrended time series data by the amplitude scaling factor.

4. The method of claim 3, further comprising:
generating a lower threshold for the amplitude scaling factor; and
applying the lower threshold while dividing the quadratically detrended time series data by the amplitude scaling factor.

5. The method of claim 1, wherein generating the time series forecast comprises:
multiplying the seasonal prediction, the quadratic trend prediction, and the amplitude scaling factor to generate the time series forecast.

6. The method of claim 1, further comprising:
using an autocorrelation function (ACF) to filter out Fourier frequencies corresponding to white noise based on a white noise threshold.

7. The method of claim 1, further comprising:
identifying unique features within the time series data based on a feature repetition threshold; and
removing from the time series data, each identified unique feature.

8. The method of claim 1, further comprising:
flattening an epoch time of a set of recent data points in the time series data.

9. The method of claim 1, wherein determining the moving median of the time series data comprises:
determining a rolling window size based on a length of the time series data; and
determining a minimum period value that allows moving median computation at an index if a number of observations greater than or equal to the minimum period value is observed in the rolling window.

10. A system comprising:
a memory; and
a processing device, operatively coupled to the memory, the processing device to:
analyze time series data using a quadratic function to determine a quadratic trend prediction;
remove the quadratic trend from the time series data to generate first detrended time series data;
determine a moving median of the time series data;
remove the moving median from the time series data to generate second detrended time series data;
determine an amplitude scaling factor based on the second detrended time series data;
descale the first detrended time series data using the amplitude scaling factor to generate descaled time series data;
analyze the descaled time series data using an attributes model to determine a seasonal prediction; and
generate a time series forecast based on the seasonal prediction, the quadratic trend prediction, and the amplitude scaling factor.

11. The system of claim 10, wherein to determine the amplitude scaling factor, the processing device is to:
compute a moving median of the second detrended time series data; and
fit a linear trend on an absolute value of the moving median of the second detrended time series data to determine the amplitude scaling factor.

12. The system of claim 10, wherein to descale the quadratically detrended time series data, the processing device is to:
divide the quadratically detrended time series data by the amplitude scaling factor.

13. The system of claim 12, wherein the processing device is further to:
generate a lower threshold for the amplitude scaling factor; and
apply the lower threshold while dividing the quadratically detrended time series data by the amplitude scaling factor.

14. The system of claim 10, wherein to generate the time series forecast, the processing device is to:
multiply the seasonal prediction, the quadratic trend prediction, and the amplitude scaling factor to generate the time series forecast.

15. The system of claim 10, wherein the processing device is further to:
use an autocorrelation function (ACF) to filter out Fourier frequencies corresponding to white noise based on a white noise threshold.

16. The system of claim 10, wherein the processing device is further to:
identify unique features within the time series data based on a feature repetition threshold; and
remove from the time series data, each identified unique feature.

17. The system of claim 10, wherein the processing device is further to:
flatten an epoch time of a set of recent data points in the time series data.

18. The system of claim 10, wherein to determine the moving median, the processing device is to:
determine a rolling window size based on a length of the time series data; and
determine a minimum period value that allows moving median computation at an index if a number of observations greater than or equal to the minimum period value is observed in the rolling window.

19. A non-transitory computer-readable medium having instructions stored thereon which, when executed by a processing device, cause the processing device to:
analyze time series data using a quadratic function to determine a quadratic trend prediction;
remove the quadratic trend from the time series data to generate first detrended time series data;
determine a moving median of the time series data;
remove the moving median from the time series data to generate second detrended time series data;
determine an amplitude scaling factor based on the second detrended time series data;
descale the first detrended time series data using the amplitude scaling factor to generate descaled time series data;
analyze the descaled time series data using an attributes model to determine a seasonal prediction; and
generate, by the processing device, a time series forecast based on the seasonal prediction, the quadratic trend prediction, and the amplitude scaling factor.

20. The non-transitory computer-readable medium of claim 19, wherein to determine the amplitude scaling factor, the processing device is to:
compute a moving median of the second detrended time series data; and
fit a linear trend on an absolute value of the moving median of the second detrended time series data to determine the amplitude scaling factor.

21. The non-transitory computer-readable medium of claim 19, wherein to descale the quadratically detrended time series data, the processing device is to:
divide the quadratically detrended time series data by the amplitude scaling factor.

22. The non-transitory computer-readable medium of claim 21, wherein the processing device is further to:
generate a lower threshold for the amplitude scaling factor; and
apply the lower threshold while dividing the quadratically detrended time series data by the amplitude scaling factor.

23. The non-transitory computer-readable medium of claim 19, wherein to generate the time series forecast, the processing device is to:
multiply the seasonal prediction, the quadratic trend prediction, and the amplitude scaling factor to generate the time series forecast.

24. The non-transitory computer-readable medium of claim 19, wherein the processing device is further to:
use an autocorrelation function (ACF) to filter out Fourier frequencies corresponding to white noise based on a white noise threshold.

25. The non-transitory computer-readable medium of claim 19, wherein the processing device is further to:
identify unique features within the time series data based on a feature repetition threshold; and
remove from the time series data, each identified unique feature.

26. The non-transitory computer-readable medium of claim 19, wherein the processing device is further to:
flatten an epoch time of a set of recent data points in the time series data.

27. The non-transitory computer-readable medium of claim 19, wherein to determine the moving median, the processing device is to:
determine a rolling window size based on a length of the time series data; and
determine a minimum period value that allows moving median computation at an index if a number of observations greater than or equal to the minimum period value is observed in the rolling window.
